(19) United States
(12) Patent Application Publication
(10) Pub. No.: US 2009/0238068 A1
(43) Pub. Date: Sep. 24, 2009

(54) METHOD, SYSTEM AND COMPUTER PROGRAM PRODUCT INVOLVING CONGESTION AND FAULT NOTIFICATION IN ETHERNET

(75) Inventors: Casimer DeCusatis, Poughkeepsie, NY (US); Thomas A. Gregg, Highland, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, ARMONK, NY (US)

(21) Appl. No.: 12/050,503

(22) Filed: Mar. 18, 2008

(51) Int. Cl. G08C 15/00

(52) U.S. Cl. 370/229

(57) ABSTRACT

A method for sending congestion notifications from a node in an Ethernet protocol including, determining whether the node is congested, generating a congestion message including a unique identifier of the node, responsive to determining that the node is congested, and sending the congestion message to a source transmitter.

### BACKGROUND OF THE INVENTION

This invention relates generally to Ethernet, and more particularly to detecting network congestion in an Ethernet protocol.

Ethernet is a frame-based networking technology for local area networks. The Ethernet protocols are standardized in, for example, IEEE 802.3. Data is sent via Ethernet protocols over networks via switches, bridges, and hubs that are hardware devices designed to transmit data with the Ethernet protocol.

Data Center Ethernet (DCE) is a modification of the Ethernet standard that may allow Ethernet to be a preferred protocol for all types of data center network traffic. This may also be known by other names, such as, for example, low latency Ethernet, next generation Ethernet, or Fibre Channel over Ethernet. The use of many different protocol standards in data centers leads to problems in implementing data center systems.

It would be desirable to develop a DCE protocol that takes advantage of the prevalent use of the Ethernet protocol and incorporates additional features for data center use.

### BRIEF SUMMARY OF THE INVENTION

An exemplary method includes sending congestion notifications from a node in an Ethernet protocol including, determining whether the node is congested, generating a congestion message including a unique identifier of the node, responsive to determining that the node is congested, and sending the congestion message to a source transmitter.

An exemplary embodiment includes, a system for transmitting data comprising a node having a unique identifier, wherein the node is operative to determine whether the node is congested, generate a congestion message including a unique identifier of the node, and send the congestion message to a source transmitter responsive to determining that the node is congested.

An alternate exemplary embodiment includes, a computer program product for providing real-time recommendations, the computer program product comprising, a computer-readable storage medium for storing instructions for executing a real-time recommendation service, the real-time recommendation service comprising a method of, determining that a node is congested, generating a congestion message including a unique identifier of the node, and sending the congestion message to a source transmitter.

### BRIEF DESCRIPTION OF THE DRAWINGS

Referring now to the drawings wherein like elements are numbered alike in the several FIGURES:

FIG. 1 illustrates an exemplary embodiment of a data network.

FIG. 2 illustrates an exemplary embodiment of a data packet.

FIGS. 3-6 illustrate an exemplary a method for notifying of network congestion.

FIG. 7 illustrates an alternate exemplary embodiment of a data packet.

FIG. 8 illustrates an exemplary method for notifying of network congestion and faults.

### DETAILED DESCRIPTION OF EXEMPLARY EMBODIMENTS

An exemplary embodiment of the present invention provides improved network congestion notification in an Ethernet protocol.

As data packets are sent over a network, a variety of network conditions may delay the data packets. Nodes such as, for example, switches and routers in the network may include buffers that save data packets. Congestion may occur at a node if, for example, the buffers fail or become full. Congestion may cause the data packets to be delayed. Faults may also occur in a node due to, for example hardware or software failures. Faults may cause data packets to be lost or delayed.

Ethernet protocols include the use of backward explicit congestion notification (BECN). When a node becomes congested, the node sends a BECN in the direction opposite the data flow. When the sender receives a BECN, the sender slows the flow of data to relieve the congestion.

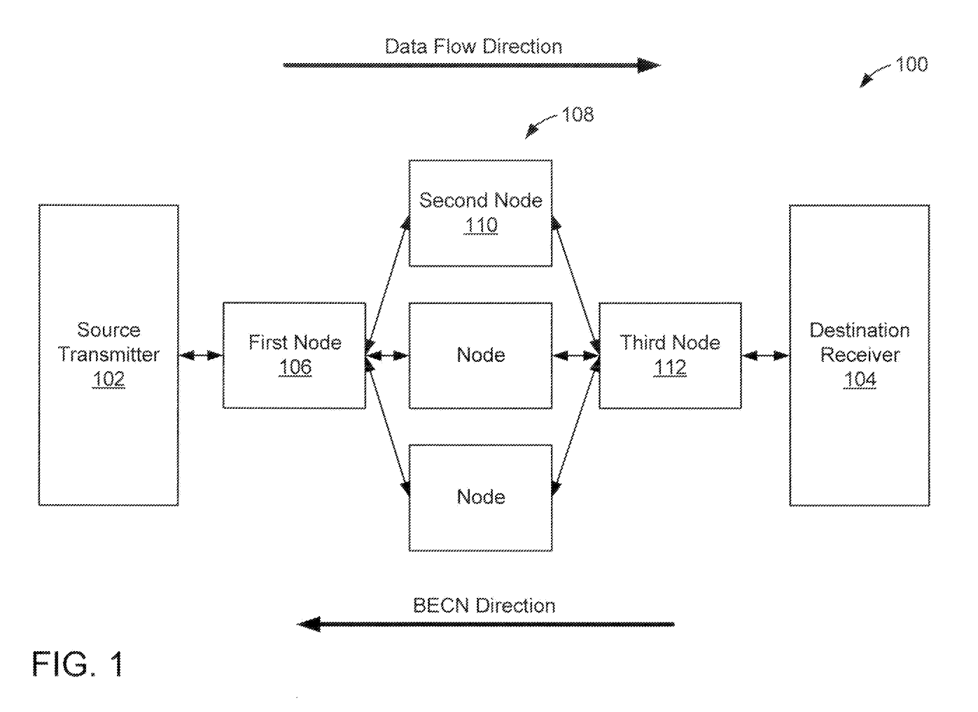

FIG. 1 illustrates an exemplary embodiment of a data network 100 including a source transmitter 102 communicatively connected to a first node 106. The first node 106 is communicatively linked to a network 108 that may include, for example, additional nodes 110 having switches and routers. The network 108 is communicatively linked to a third node 112 that is communicatively linked to a destination receiver 104.

If the data network 100 is operated according to existing Ethernet protocols, the source transmitter 102 may, for example, send data packets to the destination receiver 104 in a data flow via the first node 106, the second node 110 of the network 108, and the third node 112. If, for example, the second node 110 became congested from a full buffer, the second node 110 would send a BECN in the direction opposite the data flow-towards the source transmitter 102. Once the source transmitter 102 receives the BECN, the source transmitter 102 will slow the data flow.

A disadvantage of the BECN in existing Ethernet protocols is the BECN does not include an indication of what node has sent the BECN. Thus, the source transmitter 102 only receives a message that there is congestion somewhere in the data network 100. The source transmitter is limited to slowing the data stream to relieve the congestion.

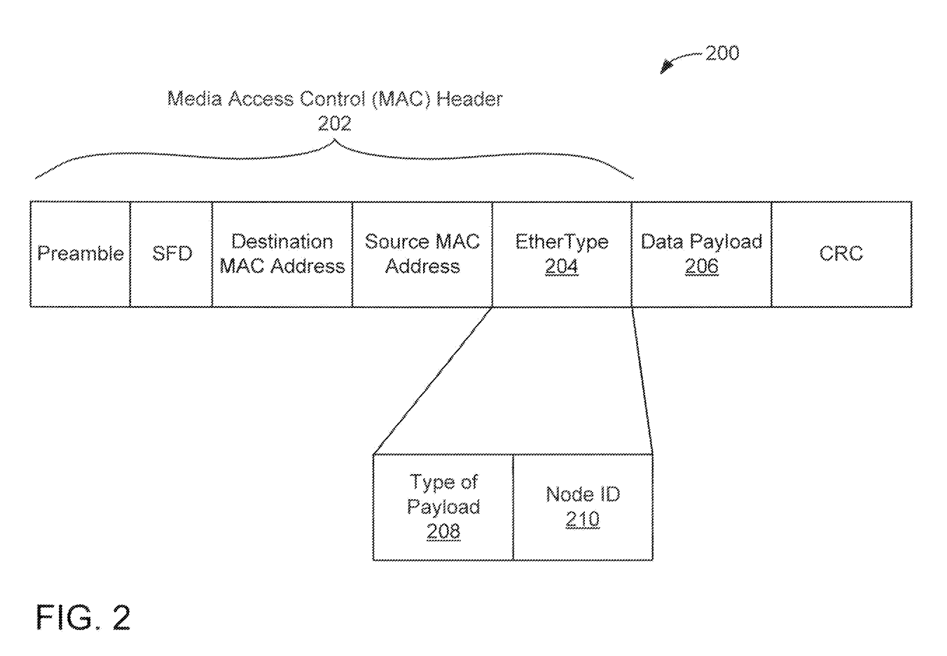

A proposed addition to the DCE protocol is adding a node identifier (Node ID). to a BECN message. A Node ID is a unique identifier of the node that is sending the BECN. FIG. 2 illustrates an exemplary embodiment of a DCE data packet 200 having a variety of fields. The data packet 200 includes a MAC header 202, a payload field 206 that holds the sent data, and an EtherType field 204.

The data packet 200 includes an expanded EtherType field 204. The EtherType field 204 includes a type of payload field 208 that is similar to conventional Ethernet type of payload fields, and a Node ID field 210. FIG. 2 illustrates the Node ID field 210 located in the EtherType field 204, however the sequence of the fields may be different and is not limited to that shown in FIG. 2. The Node ID field 210 may be located in a different field than illustrated in FIG. 2, and is not limited by FIG. 2.

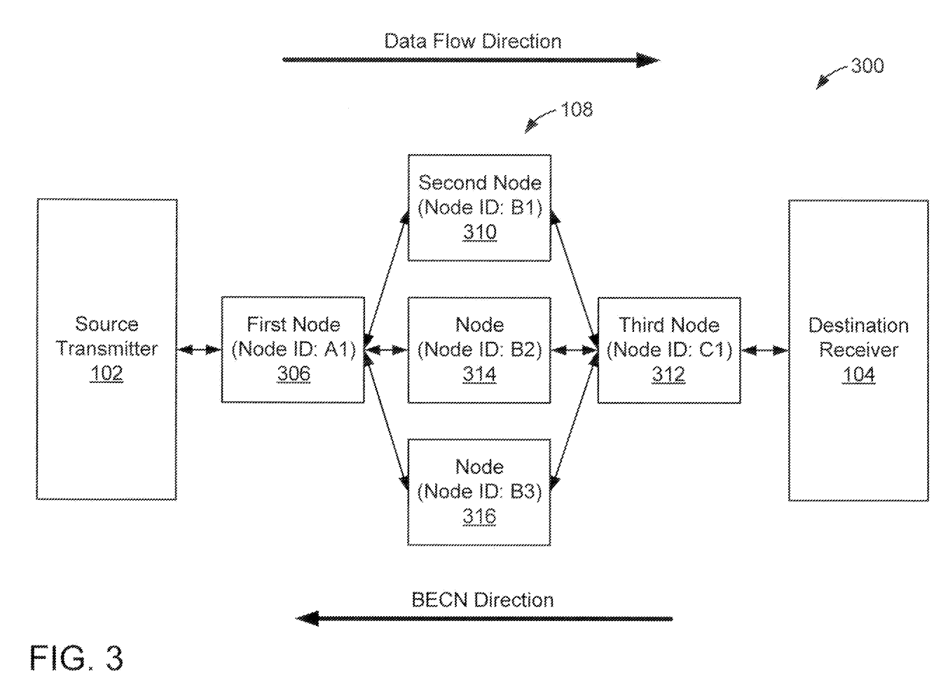

FIG. 3 illustrates an exemplary embodiment of a data network 300. The data network 300 is similar to the data network 100 described above, however the data network 300 includes nodes having Node IDs. In FIG. 3, a first node 306 has a Node ID of A1. A second node 310 has a Node ID of B1, a third node 312 has a Node ID of C1, and a fourth node 314 has a Node ID of B2. A node 316 has a Node ID of B3.

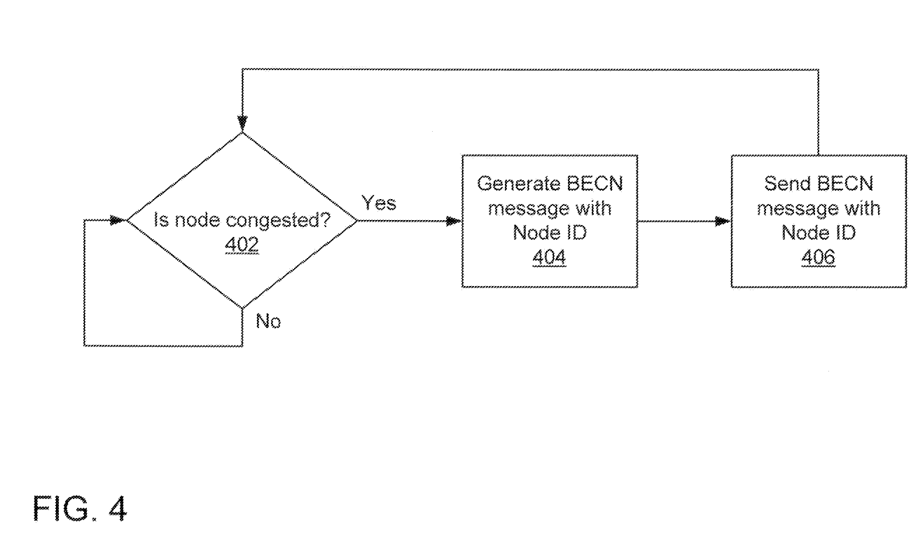

A block diagram of an exemplary method of operation is illustrated in FIG. 4. Beginning in block 402, a processor in the node determines whether the node is congested. If the node is congested, the node generates a BECN message having a Node ID that uniquely identifies the node in block 404. Once the BECN message is generated, the node sends the BECN message in block 406. Once the BECN message is sent, the method returns to block 402.

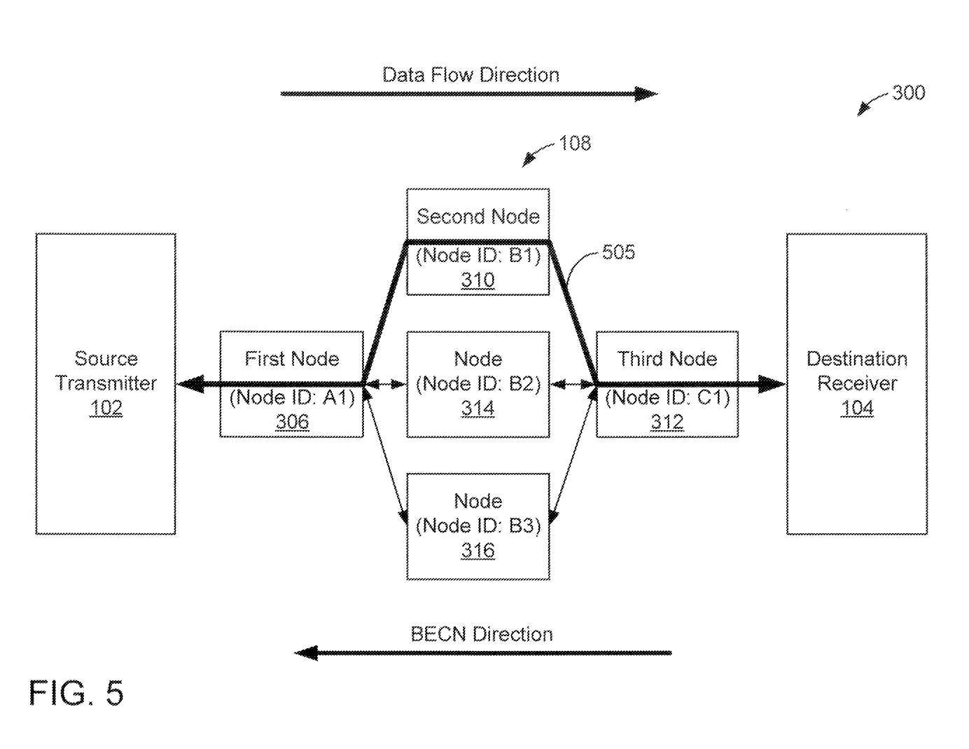

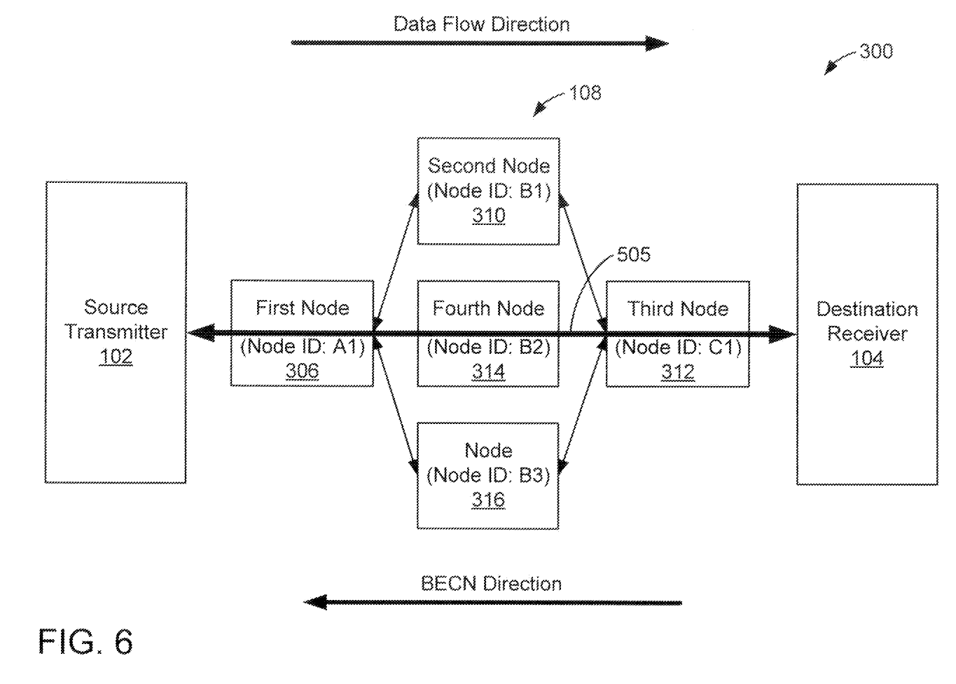

FIGS. 5 and 6 illustrate an exemplary application of the method of FIG. 4 to the data network 300. Referring to FIG. 5, the source transmitter 102 sends data packets in a data stream 505 to the destination receiver 104. The data stream 505 flows through the first node 306, the second node 310, and the third node 312. If the second node 310 determines that the second node 310 is congested, the second node 310 will generate and send a BECN having the Node ID of the second node 310 (B1). When the source transmitter 102 receives the BECN having the Node ID B1, the source transmitter 102 may slow the data flow to relieve the congestion in the second node 310. Since the source transmitter 102 has received a Node ID of the congested node, the source transmitter may also, or alternatively, reroute the data stream to avoid the congested second node 310. For example, the source transmitter 102 may reroute the data stream 505 through the fourth node 314 as shown in FIG. 6. The Node ID may also be used to troubleshoot problematic nodes in the data network 300.

Faults in nodes, such as, for example, hardware and software failures may cause data to be lost in transmission. If a fault is detected in a node, a fault message may be sent to the source transmitter 102 to notify the source transmitter 102 of the fault and an identifier of the node.

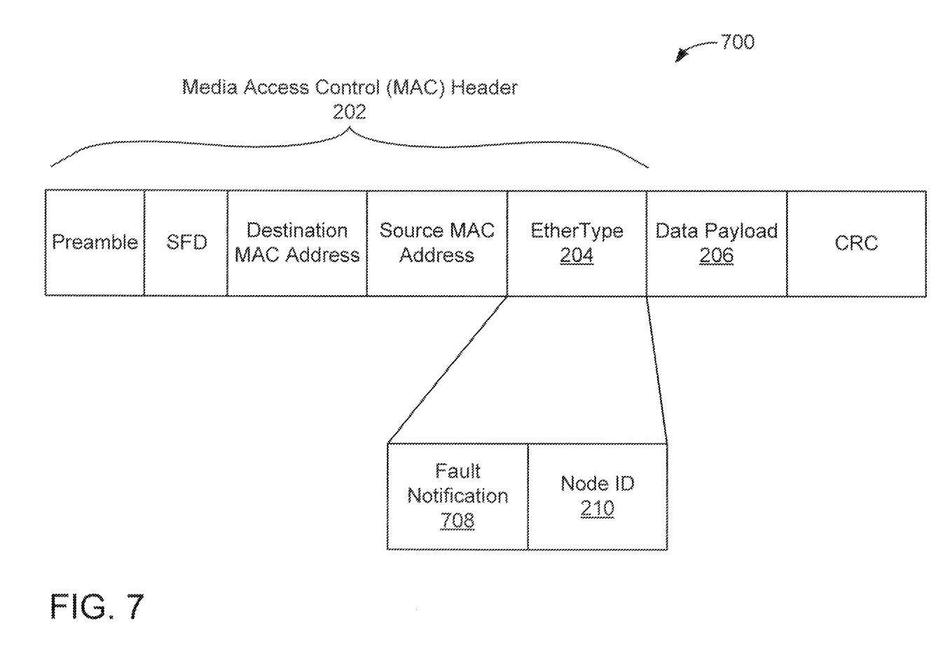

FIG. 7 illustrates an exemplary embodiment of a fault message 700. The fault message 700 is similar to the data packet 200 of FIG. 2. The fault message 700 includes a fault notification that may be located, for example, in a fault notification field 708 of the EtherType field 204.

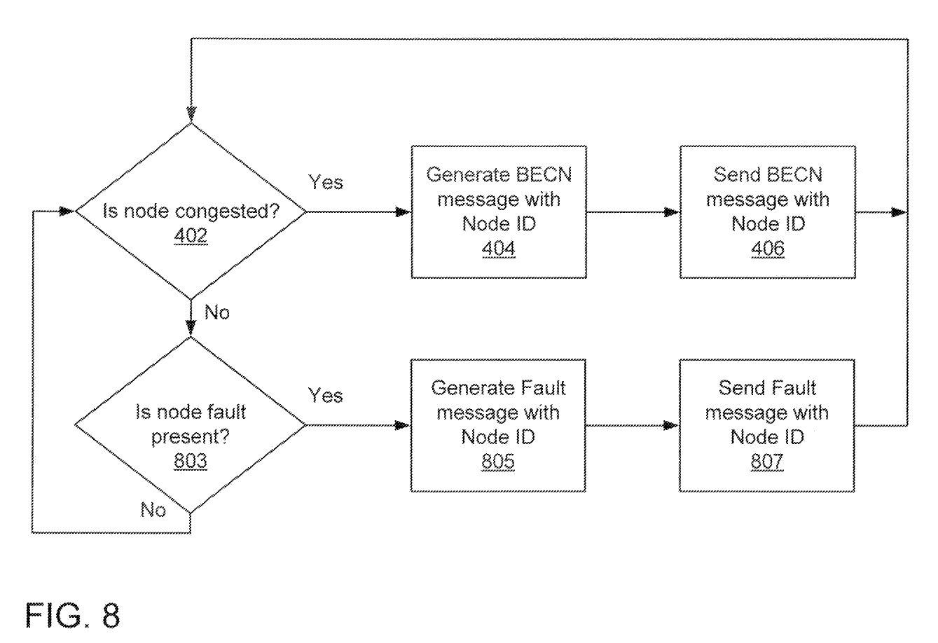

FIG. 8 illustrates an alternate embodiment of the method of FIG. 4 including node fault determination and notification. Blocks 402, 404, and 406 are similar to the blocks of FIG. 4. FIG. 8 includes a block 803 that is processed responsive to determining that a node is not congested in block 402. In block 803, a processor determines whether a node fault is present. If a node fault is not present, the method returns to block 402. If a node fault is present, a fault message with a node ID (unique identifier) of the faulty node is generated in 805. The fault message may be similar to the fault message 700 (of FIG. 7). In block 807, the fault message is sent to the source transmitter 102.

Technical effects and benefits include a method for sending BECN messages that uniquely identify a congested node that is sending the BECN. Fault messages may also be sent to identify faulty nodes. The benefit of uniquely identifying the congested or faulty node is that it allows data transmitters to reroute data streams to avoid the congested or faulty node.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. What is claimed is:

1. A method for sending congestion notifications from a node in an Ethernet protocol including:
determining whether the node is congested;
generating a congestion message including a unique identifier of the node, responsive to determining that the node is congested; and
sending the congestion message to a source transmitter.

2. The method of claim 1, wherein the congestion message is a backward explicit congestion notification (BECN).

3. The method of claim 1, wherein the unique identifier of the node is located in an EtherType field of the congestion message.

4. The method of claim 2 wherein the BECN includes an EtherType field having a field containing the unique identifier of the node.

5. The method of claim 1, further comprising:
determining whether a node fault is present responsive to determining that the node is not congested;
generating a fault message including the unique identifier of the node, responsive to determining that a node fault is present; and
sending the fault message to a source transmitter.

6. The method of claim 5, wherein the fault message includes an EtherType field having a field containing the unique identifier of the node.

7. A system for transmitting data comprising a node having a unique identifier, wherein the node is operative to determine whether the node is congested, generate a congestion message including a unique identifier of the node, and send the congestion message to a source transmitter responsive to determining that the node is congested.

8. The system of claim 7, wherein the congestion message is a backward explicit congestion notification (BECN).

9. The system of claim 7, wherein the unique identifier of the node is located in an EtherType field of the congestion message.

10. The system of claim 8, wherein the BECN includes an EtherType field having a field containing the unique identifier of the node.

11. The system of claim 7, wherein the node is further operative to determine whether a node fault is present responsive to determining that the node is not congested, generate a fault message including the unique identifier of the node, responsive to determining that a node fault is present, and send the fault message to a source transmitter.

12. The system of claim 11, wherein the fault message includes an EtherType field having a field containing the unique identifier of the node.

13. A computer program product for providing real-time recommendations, the computer program product comprising:
a computer-readable storage medium for storing instructions for executing a real-time recommendation service, the real-time recommendation service comprising a method of:
determining that a node is congested;
generating a congestion message including a unique identifier of the node; and
sending the congestion message to a source transmitter.

14. The computer program product of claim 13, wherein the congestion message is a backward explicit congestion notification (BECN).

15. The computer program product of claim 13, wherein the unique identifier of the node is located in an EtherType field of the congestion message.

16. The computer program product of claim 14, wherein the BECN includes an EtherType field having a field containing the unique identifier of the node.

17. The computer program product of claim 13, wherein the real-time recommendation service further comprises:
determining whether a node fault is present responsive to determining that the node is not congested;
generating a fault message including the unique identifier of the node, responsive to determining that a node fault is present; and
sending the fault message to a source transmitter.

18. The computer program product of claim 17, wherein the fault message includes an EtherType field having a field containing the unique identifier of the node.
